(19) United States
(12) Patent Application Publication
(10) Pub. No.: US 2011/0137561 A1
(43) Pub. Date: Jun. 9, 2011

(54) METHOD AND APPARATUS FOR MEASURING GEOGRAPHIC COORDINATES OF A POINT OF INTEREST IN AN IMAGE

(75) Inventor: Mikko KANKAINEN, Helsinki (FI)

(73) Assignee: Nokia Corporation, Espoo (FI)

(21) Appl. No.: 12/631,387

(22) Filed: Dec. 4, 2009

(51) Int. Cl. G06F 17/00

(52) U.S. Cl. 701/300

(57) ABSTRACT

An approach is provided for measuring geographic coordinates of a point of interest in an image. A mapping and augmented reality application causes, at least in part, presentation on a screen of an image including a point of interest and a reference point with a known address or known geographic coordinates, and the image is associated with a location, a tilt angle, and a directional heading of a device used to capture the image. The mapping and augmented reality application causes, at least in part, detection on the screen of a length marked by a user from the reference point to the point of interest. The mapping and augmented reality application converts the length into a physical distance between the points. The mapping and augmented reality application calculates geographic coordinates of the point of interest based upon the physical distance.

### BACKGROUND

Service providers (e.g., wireless, cellular, Internet, content, social network, etc.) and device manufacturers are continually challenged to deliver value and convenience to consumers by, for example, providing compelling network services at fast speed. One area of interest has been the development of mapping services for providing online geographic and/or location relevant content over, for instance, the Internet (e.g., digital maps, 360° panoramic street-level views of various locations, points of interest searching and suggestions, geo-tagging, and navigation, etc.), which in turn has resulted in content overload for daily usage as well as communication latency for user devices. In addition, the pre-recorded data may be out-dated, such as street views of over one year old, such that they are significantly different from current views of the same locations. Accordingly, service providers and device manufacturers face significant technical challenges to enabling users to discover and access targeted geographic and/or location relevant content efficiently.

### Some Example Embodiments

Therefore, there is a need for an approach for measuring geographic coordinates of a point of interest (POI) in an image.

According to one embodiment, a method comprises causing, at least in part, presentation on a screen of an image including a point of interest and a reference point with a known address or known geographic coordinates, the image being associated with a location, a tilt angle, and a directional heading of a device used to capture the image. The method also comprises causing, at least in part, detection on the screen of a length marked by a user from the reference point to the point of interest. The method further comprises converting the length into a physical distance between the points. The method further comprises calculating geographic coordinates of the point of interest based upon the physical distance.

According to another embodiment, an apparatus comprising at least one processor, and at least one memory including computer program code, the at least one memory and the computer program code configured to, with the at least one processor, cause, at least in part, the apparatus to cause, at least in part, presentation on a screen of an image including a point of interest and a reference point with a known address or known geographic coordinates, the image being associated with a location, a tilt angle, and a directional heading of a device used to capture the image. The apparatus is also caused to cause, at least in part, detection on the screen of a length marked by a user from the reference point to the point of interest. The apparatus is further caused to convert the length into a physical distance between the points. The apparatus is further caused to calculate geographic coordinates of the point of interest based upon the physical distance.

According to another embodiment, a computer-readable storage medium carrying one or more sequences of one or more instructions which, when executed by one or more processors, cause, at least in part, an apparatus to cause, at least in part, presentation on a screen of an image including a point of interest and a reference point with a known address or known geographic coordinates, the image being associated with a location, a tilt angle, and a directional heading of a device used to capture the image. The apparatus is also caused to cause, at least in part, detection on the screen of a length marked by a user from the reference point to the point of interest. The apparatus is further caused to convert the length into a physical distance between the points. The apparatus is further caused to calculate geographic coordinates of the point of interest based upon the physical distance.

According to another embodiment, an apparatus comprises means for causing, at least in part, presentation on a screen of an image including a point of interest and a reference point with a known address or known geographic coordinates, the image being associated with a location, a tilt angle, and a directional heading of a device used to capture the image. The apparatus also comprises means for causing, at least in part, detection on the screen of a length marked by a user from the reference point to the point of interest. The apparatus further comprises means for converting the length into a physical distance between the points. The apparatus further comprises means for calculating geographic coordinates of the point of interest based upon the physical distance.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of measuring geographic coordinates of a point of interest in an image, according to one embodiment;

FIG. 2 is a diagram of the components of a mapping and augmented reality application, according to one embodiment;

FIG. 3 is a flowchart of a process for measuring geographic coordinates of a point of interest in an image, according to one embodiment;

FIG. 4 is a flowchart of a process for providing content specifically directed to a point of interest in an image, according to one embodiment;

FIGS. 5A-5B are conceptual diagrams for converting the length on screen into a physical distance between the points of the structure, according to various embodiments;

FIGS. 6A-6C are diagrams of user interfaces utilized in the process of FIG. 3, according to various embodiments;

FIG. 7 is a diagram of a user interface utilized in the process of FIG. 3, according to one embodiment;

FIG. 8 is a diagram of hardware that can be used to implement an embodiment of the invention;

FIG. 9 is a diagram of a chip set that can be used to implement an embodiment of the invention; and

FIG. 10 is a diagram of a mobile terminal (e.g., handset) that can be used to implement an embodiment of the invention.

### DESCRIPTION OF SOME EMBODIMENTS

Examples of a method, apparatus, and computer program for measuring geographic coordinates of a point of interest in an image are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known hardware components and devices are shown in block diagram form in order to avoid unnecessarily obscuring the embodiments of the invention.

As used herein, the term “image” refers to one or a series of images taken by a camera (e.g., a still camera, digital camera, video camera, camera phone, etc.) or any other imaging equipment. Although various embodiments are described with respect to a live camera view, it is contemplated that the approach described herein may be used with other images (e.g., a photo, etc.) as long as a point of interest can be displayed therein together with a reference point with a known address or known geographic coordinates, and the image is associated with a location, tilt angle, and heading of the imaging device (e.g., camera) at the time of image capture.

As used herein, the term “structure” refers to large object permanently fixed to ground surface or in a planet's orbit, as a result of construction. Structures include a building, bridge, tower, dam, landmark, framework, factory, manufacturing plant, space shuttle, etc. Although various embodiments are described with respect to a structure, it is contemplated that the approach described herein may be used with other points of interest as long as a point of interest can be displayed in an image together with a reference point with a known address or known geographic coordinates.

As used herein, the term “point of interest” refers to any point in space specified by a user in an image. By way of example, the point of interest in an image can be an observation deck or a roof of a tower, an antenna or a window of a building, a carousel in a park, etc.

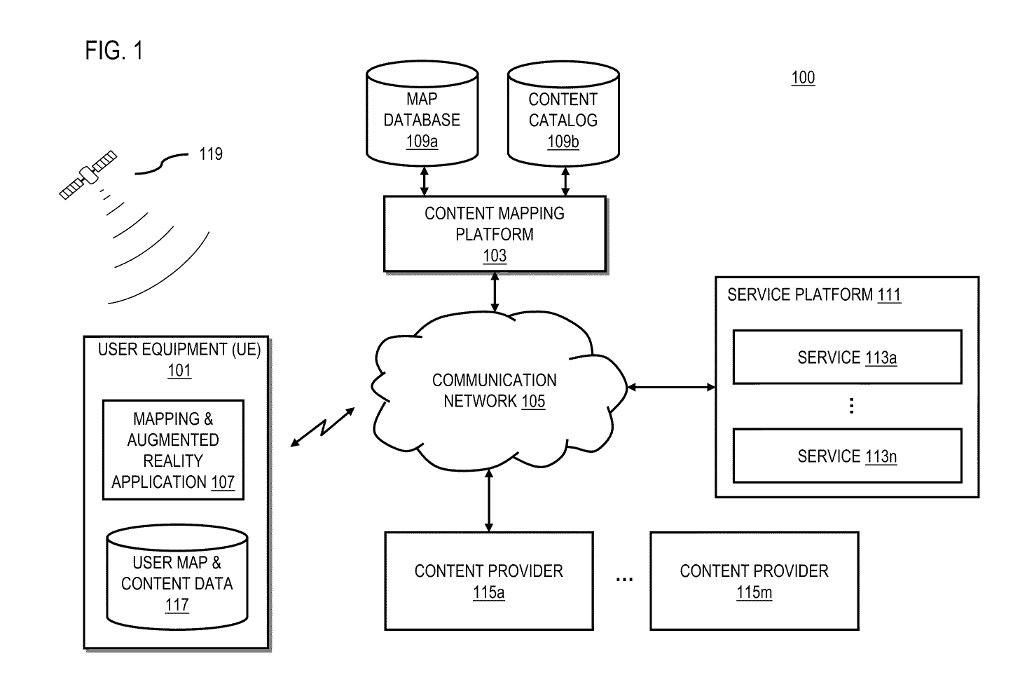

FIG. 1 is a diagram of a system capable of measuring geographic coordinates of a point of interest in an image, according to one embodiment. As mentioned previously, a large amount of geographic or location relevant content (e.g., digital maps, 360° panoramic street-level views of various locations, points of interest searching and suggestions, geo-tagging, and navigation, etc.) can be accessed over the Internet, using computers, mobile devices, and other Internet-connected devices. In many cases, the content is globally available and free. The vast collection of location and geographic coordinates data and related content available over the Internet is overwhelming for a user to access or manipulate. It is possible to use geographic coordinate data to retrieve relevant content. However, geographic coordinate data in some databases are limited to well-known landmarks (such as the Washington Monument, the Eiffel Tower, etc.), rather than available for any points of interest in space (e.g., a level or a window of the landmarks). There are pre-recorded geographic coordinate data stored in a virtual/digital map information system. However, it takes time to access such a complicated system and the data may be out-dated. When a user is walking on the Las Vegas Strip and wants to find out a height of an Eiffel-look-alike tower, the user wants to obtain the altitude data right there and right then, without maneuvering via layers of internet browsing.

Taking the Trump Building in New York City (the world's tallest building in 1930, with 70 stories and reaching 927 feet or 282.5 meters high) as an example, the user should be able to find out the height of the antenna or the height of a vertical section of the Trump Building without browsing the Internet and/or importing a complicated 3D mapping model. Traditionally, the user can download a 2D digital map showing a marker of the Building and details of the building such as a title of “Trump Building,” a description of “40 Wall Street, New York City,” and a default/reference attitude of “0 meter.” The ground floor of the Building is set as a reference point. The user then generally needs to enter an estimated altitude for a point of interest in the image (e.g., a live camera view) of the Building, such as the second section of the Trump Building, e.g., 50 m to set the geographic coordinates of the point of interest to, for instance, a point other than the ground floor. Because the altitude data is usually not known, the user may have to try different altitudes to find the one that works best. The user then can retrieve content specially directed to the point of interest, such as the floor number corresponding to the point of interest, facilities on the floor, etc. This traditional process can be quite cumbersome because the user has to guess at an appropriate altitude or height of a point of interest with respect to the reference point (e.g., the ground floor of the Trump Building).

It is noted that although GPS navigation units display altitude data, it is difficult to use the GPS altitude reading to determine the POI height. The user has to bring a GPS unit to the points of interest, i.e., the antenna or the point between the first and second vertical sections of the Trump Building, to get the geographic coordinates (including altitude readings). These limitations make it hard to determine an altitude of a POI without, for instance, browsing the Internet or physically visiting the POI at the respective altitude. As a result, user may be discouraged from exploring information or data specifically directed to a POI or a portion of the POI.

To address the problems described above, a system 100 of FIG. 1 introduces the capability of presenting a simple and intuitive interface which enables the user to measure geographic coordinates of a point of interest in an image (e.g., a live camera view). More specifically, the system 100 utilizes augmented reality (e.g., using live or actual images of a location) to receive a POI indication on a live camera view of a structure (e.g., the Trump Building) on a screen. In particular, the system 100 detects on the screen a length measurement or distance from one reference point (with a known address or known geographic coordinates) to the POI in the view as marked by a user, retrieves position data of a current user location and a location of the POI, calculates a distance between the two locations, detects a dragging length between the reference point and the POI in pixels (or other measurement unit specific to the display area of the user device displaying the live camera view), converts the dragging length into a physical distance between the two points by utilizing the location distance, the camera's field of view (FOV), and a dimension of the touch screen in pixels. Once the length is determined, the system 100 anchors a POI label at the POI in the view. By way of example, when the reference point and the POI are aligned vertically, the length represents an altitude difference. Similarly, when the reference point and the POI are aligned horizontally, the length represents a distance or a horizontal position movement on the structure, such as a width of a building, a distance between two columns of a bridge, etc.

In certain circumstances, the UE 101 is tilted to show the live image of the POI on the screen. For example, as the user walks closer to the Trump Building, the field of view of the camera becomes shorter such that the screen only shows a vertical section of the Building. To view the Building or a desired portion of the Building, the user tilts the UE 101 back ensure the Building or the portion remains in the field of view of the UE 101. As such, the conversion of the dragging length to the length is modified by considering the device's tilted angle.

In another embodiment, the system 100 further utilizes the augmented reality or augmented virtuality (e.g., using 3D models and 3D mapping information) to present content information relevant to the determined altitude, or geographic coordinates of the POI. By way of example, the content information may include: (1) a floor plan of the floor corresponding to the POI, (2) the occupants/shops/facilities located on the floor (e.g., in thumbnail images, animation, audio alerts, etc.), (3) introduction and background content with respect to the occupants/shops/facilities, (4) marketing and sales content with respect to the occupants/shops/facilities, or any other data or information tied to the floor. It is also contemplated that content may be associated with multiple floors when the POI corresponds to the multiple floors in a live camera view. The content information includes live media, stored media, metadata associated with media, text information, location information of other user devices, mapping data, geo-tagged data, or a combination thereof.

In another embodiment, the system 100 enables the user to browse available content of the POI by time. For example, the user can specify a time in the past, present, or future. The system 100 then determines the content with respect to the specified period of time and matches the content based on the specified time. In this way, the user can view content relevant to the POI at any particular time. For example, to view upcoming 1-hour sales items for babies clothes and plan when to visit the particular stores on the floor at the new altitude, the system 100 enables the user to specify the 1-hour time period and displays to the user detailed sales content, a corresponding floor plan and a walking route to the store.

As shown in FIG. 1, a user equipment (UE) 101 may retrieve content information (e.g., content and location information) and mapping information (e.g., maps, GPS data, etc.) from a content mapping platform 103 via a communication network 105. The content and mapping information can be used by a mapping and augmented reality application 107 on the UE 101 (e.g., an augmented reality application, navigation application, or other location-based application). In the example of FIG. 1, the content mapping platform 103 stores mapping information in the map database 109a and content information in the content catalog 109b. By way of example, mapping information includes digital maps, GPS coordinates, geo-tagged data, points of interest data, or a combination thereof. By way of example, content information includes one or more identifiers, metadata, access addresses (e.g., network address such as a Uniform Resource Locator (URL) or an Internet Protocol (IP) address; or a local address such as a file or storage location in a memory of the UE 101, description, or the like associated with content. In one embodiment, content includes live media (e.g., streaming broadcasts), stored media (e.g., stored on a network or locally), metadata associated with media, text information, location information of other user devices, or a combination thereof. The content may be provided by the service platform 111 which includes one or more services 113a-113n (e.g., music service, mapping service, video service, social networking service, content broadcasting service, etc.), the one or more content providers 115a-115m (e.g., online content retailers, public databases, etc.), other content source available or accessible over the communication network 105.

Additionally or alternatively, in certain embodiments, a user map and content database 117 of the UE 101 may be utilized in conjunction with the application 107 to present content information, location information (e.g., mapping and navigation information), availability information, etc. to the user. The user may be presented with an augmented reality interface associated with the application 107 and/or the content mapping platform allowing 3D objects or other representations of content and related information to be superimposed onto an image of a physical environment on the UE 101. In certain embodiments, the user interface may display a hybrid physical and virtual environment where 3D objects from the map database 109a are superimposed on top of a physical image.

By way of example, the UE 101 may execute the application 107 to receive content and/or mapping information from the content mapping platform 103 or other component of the network 105. As mentioned above, the UE 101 utilizes GPS satellites 119 to determine the location of the UE 101 to utilize the content mapping functions of the content mapping platform 103 and/or the application 107, and the map information stored in the map database 109a may be created from live camera views of real-world buildings and other sites. As such, content can be augmented into live camera views of real world locations (e.g., based on location coordinates such as global positioning system (GPS) coordinates).

The application 107 and content mapping platform 103 receive access information about content, determines the availability of the content based on the access information, and then presents a live view of the structure with augmented content (e.g., a live camera view of the Trump Building with augmented content of a point of interest on the building, such as its altitude, corresponding floor plan, facilities information, etc.).

In certain embodiments, the map information may include 2D and 3D digital maps of objects, facilities, and structures in a physical environment (e.g., buildings).

By way of example, the communication network 105 of the system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), satellite, mobile ad-hoc network (MANET), and the like.

The UE 101 is any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), or any combination thereof. It is also contemplated that the UE 101 can support any type of interface to the user (such as “wearable” circuitry, etc.).

By way of example, the UE 101, and content mapping platform 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the application 107 and the content mapping platform 103 may interact according to a client-server model, so that the application 107 of the UE 101 requests mapping and/or content data from the content mapping platform 103 on demand. According to the client-server model, a client process sends a message including a request to a server process, and the server process responds by providing a service (e.g., providing map information). The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

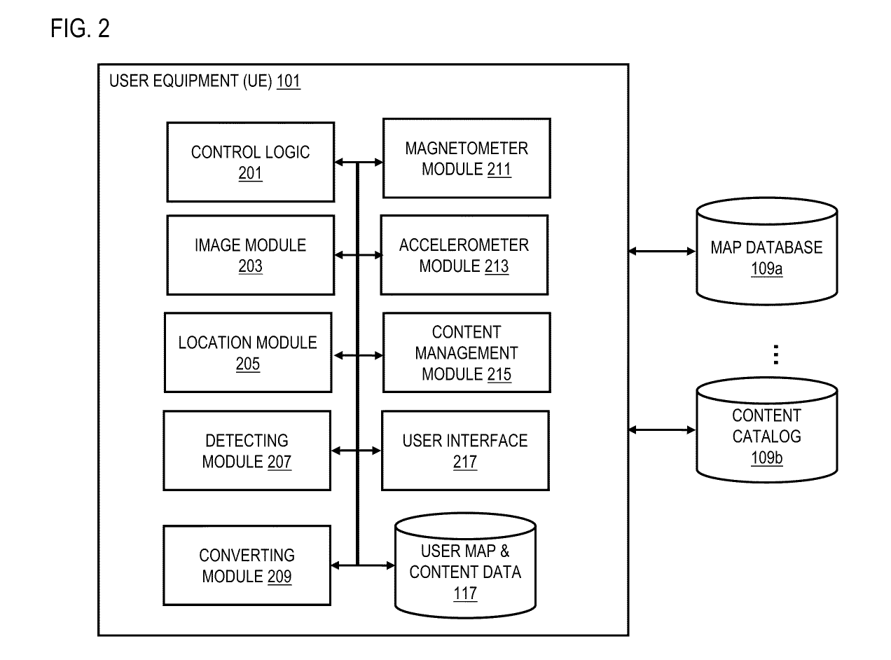

FIG. 2 is a diagram of the components of a mapping and augmented reality application, according to one embodiment. By way of example, the mapping and augmented reality application 107 includes one or more components for measuring geographic coordinates of a point of interest in a live camera view. It is contemplated that the functions of these components may be combined in one or more components or performed by other components of equivalent functionality. In this embodiment, the mapping and augmented reality application 107 includes at least a control logic 201 which executes at least one algorithm for executing functions of the content mapping platform 103. For example, the control logic 201 interacts with an image module 203 to obtain a live camera view including a structure of interest, such as the Trump Building.

Next, the control logic 201 interacts with a location module 205 to determine the current location of the UE 101 and a location of the reference point. In one embodiment, the location information may include addresses, geographic coordinates (e.g., GPS coordinates) or other indicators (e.g., longitude and latitude information) that can be associated with an existing location of the reference point. For example, the location information may be manually entered by the user (e.g., entering an address or title, clicking on a digital map, etc.) or extracted or derived from any geo-tagged data. It is contemplated that the location information or geo-tagged data could also be created by the location module 205 by deriving the location associated metadata such as media titles, tags, and comments. More specifically, the location module 205 can parse the metadata for any terms that indicate association with a particular location.

In one embodiment, the location module 205 determines the user's location by a triangulation system such as a GPS, assisted GPS (A-GPS) A-GPS, Cell of Origin, wireless local area network triangulation, or other location extrapolation technologies. Standard GPS and A-GPS systems can use satellites 119 to pinpoint the location (e.g., longitude, latitude, and altitude) of the UE 101. A Cell of Origin system can be used to determine the cellular tower that a cellular UE 101 is synchronized with. This information provides a coarse location of the UE 101 because the cellular tower can have a unique cellular identifier (cell-ID) that can be geographically mapped. The location module 205 may also utilize multiple technologies to detect the location of the UE 101. GPS coordinates can provide finer detail as to the location of the UE 101. As previously noted, the location module 309 may be utilized to determine location coordinates for use by the application 107 and/or the content mapping platform 103.

Again, the control logic 201 interacts with the image module 203 to display the live camera view and location information of a structure (e.g., the Trump Building), as well as a reference point set in relation to the building (e.g., at the ground floor of the Trump Building).

While displaying the live camera view of the structure, the control logic 201 interacts with the image module 203 to prompt the user to move a finger thereby dragging the POI label upwards to a point of interest and then releasing the label. The control logic 201 interacts with a detecting module 207 to detect a dragging length on the screen in pixels, and interacts with a converting module 209 to convert the dragging length into an altitude or distance difference. The converting module 209 interacts with a magnetometer module 211 which determines horizontal orientation or directional heading (e.g., a compass heading) of the UE 101, and an accelerometer module 213 which determines vertical orientation or an angle of elevation of the UE 101.

The magnetometer module 211 can include an instrument that can measure the strength and/or direction of a magnetic field. Using the same approach as a compass, the magnetometer is capable of determining the directional heading of a UE 101 using the magnetic field of the Earth. The front of the image capture device (e.g., a digital camera) (or another reference point on the UE 101) can be marked as a reference point in determining direction. Thus, if the magnetic field points north compared to the reference point, the angle the UE 101 reference point is from the magnetic field is known. Simple calculations can be made to determine the direction of the UE 101. In one embodiment, horizontal directional data obtained from a magnetometer is utilized to determine the orientation of the user. This directional information may be correlated with the location information of the UE 101 to determine where (e.g., at which geographic feature or object) the UE 101 is pointing towards. This information may be utilized to select a first person view to render content and mapping information.

Further, the accelerometer module 213 may include an instrument that can measure acceleration. Using a three-axis accelerometer, with axes X, Y, and Z, provides the acceleration in three directions with known angles. Once again, the front of a media capture device can be marked as a reference point in determining direction. Because the acceleration due to gravity is known, when a UE 101 is stationary, the accelerometer module 213 can determine the angle the UE 101 is pointed as compared to Earth's gravity. In one embodiment, vertical directional data obtained from an accelerometer is used to determine the angle of elevation or tilt angle at which the UE 101 is pointing. This information in conjunction with the magnetometer information and location information may be utilized to determine a viewpoint to provide content and mapping information to the user. As such, this information may be utilized in selecting available content items to present navigational information to the user. Moreover, the combined information may be utilized to determine portions of a particular digital map or augmented reality view that may interest the user. In one embodiment, if the location information associated with one or more available content items does not correspond to the viewpoint (e.g., is not visible in the selected viewpoint), one or more indicators (e.g., arrows or pointers) may be showed on the user interface to indicate the direction towards the location of the content items.

The control logic then interacts with the image module 203 to render an altitude or distance of the POI from the reference point in the POI label, and to fix the POI label at the POI in the live camera view of the Trump Building, regardless how the user moves the UE 101.

The control logic 201 then interacts with a content management module 215 and the image module 203 to present optional content information related to the POI. The content may be received from the service platform 111, the services 113a-113n, the content providers 115a-115m, other like components, or a combination thereof. It is also contemplated that the user or another party authorized by the user may manually enter a content item. In one embodiment, the content management module 215 may create a content catalog listing all content items and associated access addresses provided to the content management module 215. In certain embodiments, the content catalog may include additional descriptive information and other metadata describing the content. The available media content or stream can take many forms (e.g., live video feeds, photographs, audio files, etc.) and can be delivered using any number means (e.g., streaming media, downloaded media, spontaneously created media, etc.). The content management module 215 includes one or more sub-modules or application programming interfaces (APIs) (not pictured) for receiving and/or detecting the media content in its native format or for converting the media content to a media format compatible with the mapping and augmented reality application 107. In other embodiments, the content management module 215 may initiate a download or installation of the components (e.g., codecs, player applications, etc.) needed to verify the content or stream. The content data can be cached or save in the user map and content database 117.

To facilitate finding specific content or features, the content management module 215 enables the user to input search criteria (e.g., a content item, person, city, weather, etc.) and to get guidance for finding the direction where the searched content item is located in the real physical world. The content management module 215 also enables a user to specify a time period so as to navigate content information using both location and time. In one embodiment, the default time for viewing the content and mapping information is the present. If a time period is set as future, the content management module 215 will determine the one or more content items based on the specified time, such as what will be on sales in the next three hours on the 4^{th} to 5^{th} floors of the Trump Building. By way of example, the sales content and product information can be presented on a floor plan with representations of each product placed according to the associated location information.

The content can be depicted as a thumbnail overlaid on the user interface map at the location corresponding to a point of interest (e.g., a floor) or a portion of the point of interest (e.g., facilities on the floor). As discussed, the user interface may be a graphical user interface. In addition or alternatively, the user interface may be an audio or tactile interface. In one embodiment, the content management nodule 215 presents only those content items that are available at the specified time and are not associated with any limitations or exclusive restrictions. This embodiment provides a user experience in which users can simply select from the presented content items and be assured that the selected item will be available with a single selection click. In other embodiments, the content management nodule 215 may present all available content and differentiate the presentation of content available with a single click versus content associated with additional limitations or restrictions. The specific types of presentations can be specified by the user, content provider 115, network operator, service platform 111, or a combination thereof. The content management nodule 215 then determines whether to periodically update the content information.

In certain embodiments, when there is much more content available than can be displayed in the existing user interface, the content management nodule 215 constantly animates the display of the content items so that new content keeps appearing while older content disappears. This animation process also makes the user interface more entertaining to users and gives a feeling of the world being “alive” with activity.

In certain embodiments, the user map and content database 117 includes all or a portion the information in the map database 109a and the content catalog 109b. From the selected viewpoint, an image representing an augmented reality view can be generated or retrieved from the database 117 or the content mapping platform 103.

Content and mapping information may be presented to the user via a user interface 217, which may include various methods of communication. For example, the user interface 217 can have outputs including a visual component (e.g., a screen), an audio component (e.g., a verbal instructions), a physical component (e.g., vibrations), and other methods of communication. User inputs can include a touch-screen interface, microphone, camera, a scroll-and-click interface, a button interface, etc. Further, the user may input a request to start the application 107 (e.g., a mapping and augmented reality application) and utilize the user interface 217 to receive content and mapping information. Through the user interface 217, the user may request different types of content, mapping, or location information to be presented. Further, the user may be presented with 3D or augmented reality representations of particular locations and related objects (e.g., buildings, terrain features, POIs, etc. at the particular location) as part of a graphical user interface on a screen of the UE 101. As mentioned, the UE 101 communicates with the content mapping platform 103 service platform 111, and/or content providers 115a-115m to fetch content, mapping, and or location information. The UE 101 may utilize requests in a client server format to retrieve the content and mapping information. Moreover, the UE 101 may specify location information and/or orientation information in the request to retrieve the content and mapping information.

The image module 203 may include a camera, a video camera, a combination thereof, etc. In one embodiment, visual media is captured in the form of an image or a series of images. The image module 203 can obtain the image from a camera and associate the image with location information, magnetometer information, accelerometer information, or a combination thereof. As previously noted, this combination of information may be utilized to determine the physical distance of two points on the building by combining the location of the user, horizontal orientation information of the user, and vertical orientation information of the user. This information may be utilized to retrieve content and mapping information from the user map and content database 117 or the mapping platform 103.

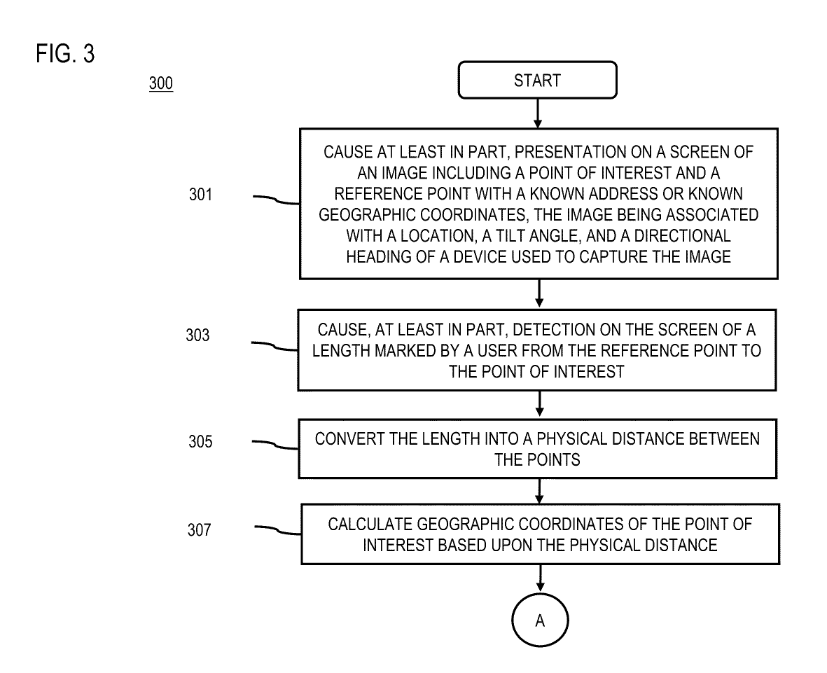

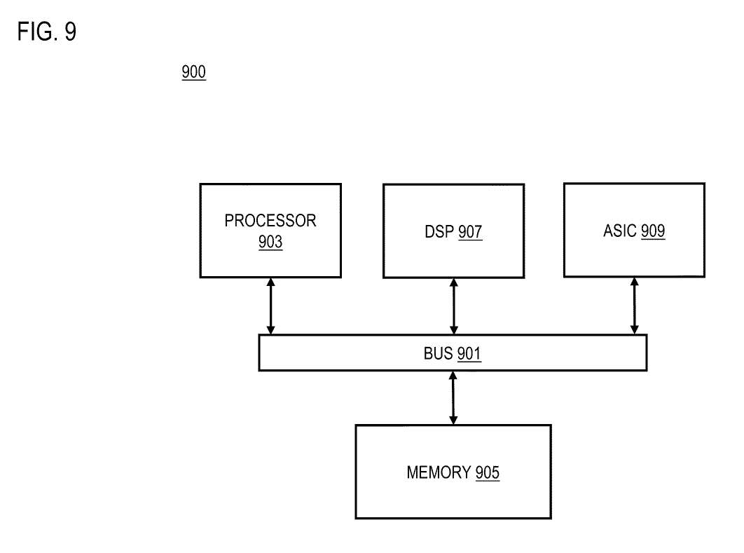

FIG. 3 is a flowchart of a process for measuring geographic coordinates of a point of interest in an image, according to one embodiment. In one embodiment, the mapping and augmented reality application 107 performs the process 300 and is implemented in, for instance, a chip set including a processor and a memory as shown FIG. 9. In step 301, the mapping and augmented reality application 107 causes, at least in part, presentation on a screen of an image (e.g., a live camera view) including a point of interest and a reference point (e.g., the ground floor of the Trump Building) with a known address or known geographic coordinates, and the live camera view is associated with a location, a tilted angle and heading of an apparatus used to take the image. An inherent property of an augmented reality user interface is that the displayed content is dependent on the viewpoint and that to view a specific point or content located on the ground, the user has to point the UE 101 in the structure of interest. The user can drag the POI label vertically from the ground floor to set a POI. After the user taps the POI label and drags it towards a desired POI, the mapping and augmented reality application 107 causes, at least in part, detection on the screen of a length marked by a user from the reference point to the POI (Step 303).

The mapping and augmented reality application 107 converts the length on the screen into a physical distance between the reference point and the POI (Step 305). The vertical drag (in pixels) is converted to altitude reading (meters) by utilizing the distance from a current physical location of the UE 101 to a physical location of the reference point (in meters), a camera viewfinder's field of view (FOV) angle, and a screen dimension in pixels. If during dragging the user also tilts the UE 101 to show the top of the Building, the conversion needs to consider the device's tilt angle.

As noted previously, an inherent property of an augmented reality user interface is that the display follows the movement and pointing of the UE 101. However, in some cases (e.g., when the user has found and is displaying a favorite location), the user may wish to “lock” or fix the display at a particular viewpoint without having to maintain the UE 101 in the same position. When seeing the top of the Building, the user then drags the POI label to the desired position and lifts the finger to save the position of the POI. Thereafter, the mapping and augmented reality application 107 calculates geographic coordinates of the POI based upon the physical distance between the physical location the UE 101 and the physical location of the reference point (Step 307).

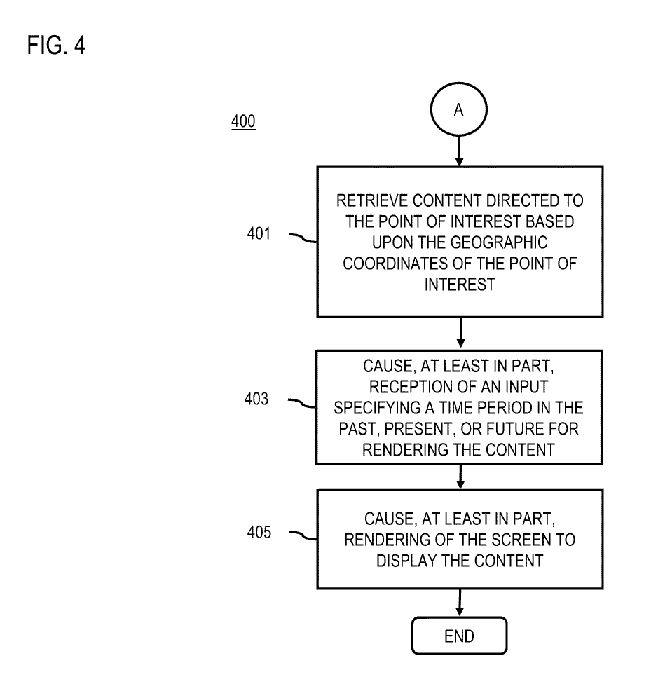

FIG. 4 is a flowchart of a process for providing content specifically directed to a point of interest in an image, according to one embodiment. In one embodiment, the mapping and augmented reality application 107 performs the process 400 and is implemented in, for instance, a chip set including a processor and a memory as shown FIG. 9. In step 401, the mapping and augmented reality application 107 retrieves content directed to the point of interest based upon the geographic coordinates of the point of interest. By way of example and continuing with the example of the Trump Building discussed above, the application 107 associates the POI to the 4^{th} floor of the Trump Building based upon the calculated geographic coordinates. The application 107 then retrieves the sales content and product information available for the 4^{th} floor.

The mapping and augmented reality application 107 causes, at least in part, reception of an input specifying a time period in the past, present, or future for rendering the content (Step 403). The application 107 also prompts the user to specify a time period so as to retrieve content using both location and time. In one embodiment, the default time for viewing the content and mapping information is the present. If a time period is set as future, the application 107 determines the content based on the specified time, such as what will be on sale in the next hour on the 4^{th} floors of the Trump Building.

The mapping and augmented reality application 107 causes, at least in part, rendering of the screen to display the content (Step 405). The application 107 presents the sales content and product information of the next hour on a floor plan with representations of each product placed according to their location on the 4ht floor.

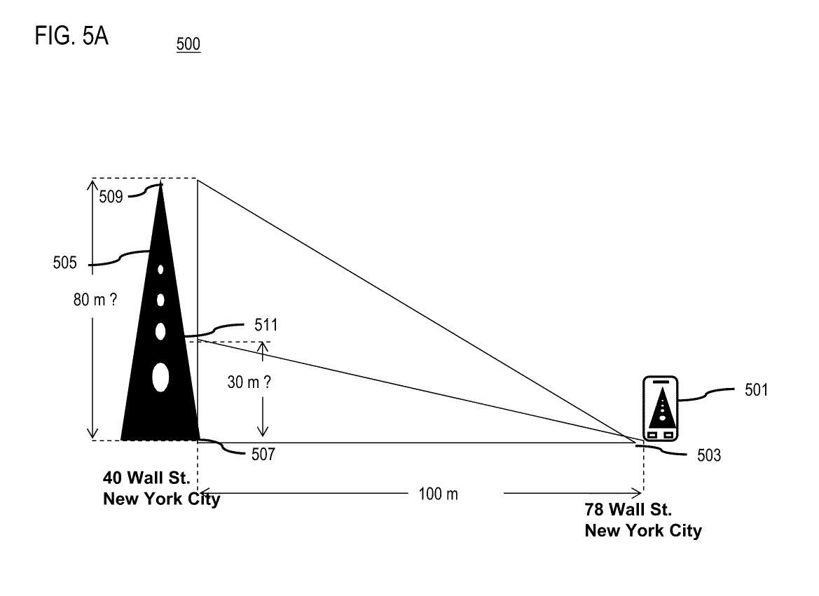

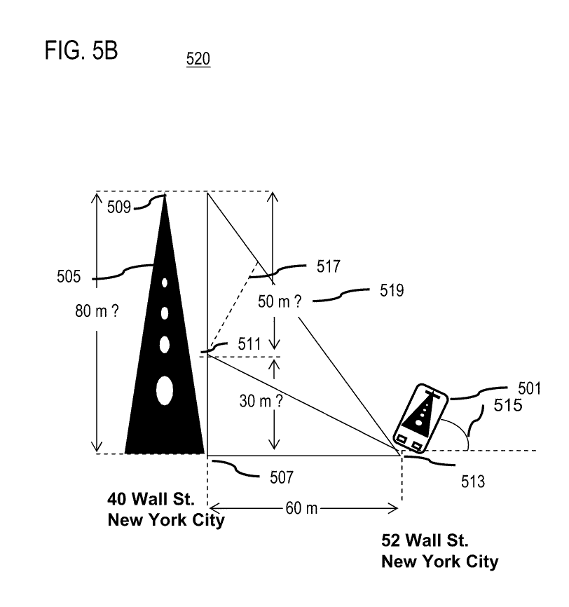

FIGS. 5A-5B are conceptual diagrams for converting the length on screen into a physical distance between the points of the structure, according to various embodiments. A field of view (also field of vision) is the (angular or linear or areal) extent of the observable building that is seen at any given moment. The field of view is that part of the building that is visible through the camera at a particular position and orientation in space. The “FOV formula” is derived from similar triangles and can be used for (amongst other things) calculating the ‘dimension’ of the FOV at a given distance:

$$\frac{o}{d} = \frac{i}{f}$$

The variable o is the physical distance between the reference point and the POI in meter (or “field of view” perpendicular to and bisected by the optical axis). The variable d is the location distance in meter (from the current location of the UE 101 to the current location of the reference point). The variable i is a dragging length on the screen in pixel. The variable f is the on screen dimension in pixel. The dimensions for o and i is in the same diagonal, horizontal or vertical plane; so the horizontal object dimension corresponds to the horizontal image dimension.

By way of example, the user is holding the UE 501 straight up and down (without tilting) at a current location 503 (78 Wall Street, New York City) in FIG. 5A. The screen shows the Trump Building 505 at a location 507 (78 Wall Street, New York City) occupying 80% of the vertical dimension of the live camera view. The user then drags the POI label from the bottom 507 to the top 509 of the Building in the live camera view. The application 107 detects the dragging length as approximately 80% of the vertical dimension of the screen, and retrieves from its own database 117 a distance between 78 wall Street and 40 Wall Street (e.g., 100 meters), to calculate the physical distance between the points on the building as follows.

80%=O/100, O=80 meters

Therefore, the application 107 estimates the top of the Trump Building has a height/altitude of 80 meter. If the user only drags the POI label from the bottom 507 to an intermediate point 511 of the Building in the live camera view, the application 107 detects the dragging length as approximately 30% of the vertical dimension of the screen and calculates the physical distance between the points on the building as 30 meters.

As the user walks closer to the Trump Building, such as to a location 513 (52 wall Street) being 60 meters away, the screen of the UE 501 can only display a section of the building. In order to display the top of the building in the live camera view, the user has to tilt the UE 501 at an angle 515 as shown in FIG. 5B. For example, the application 107 detects the dragging length as approximately 30% of the vertical dimension of the screen. In this case, o is “field of view” 517 perpendicular to and bisected by the optical axis, and o is 30 meters. The FOV 517 has to be converted into the physical distance 519 between the points on the Building using the angle 515. The physical distance 519 between the points on the building is calculated as about 50 meters.

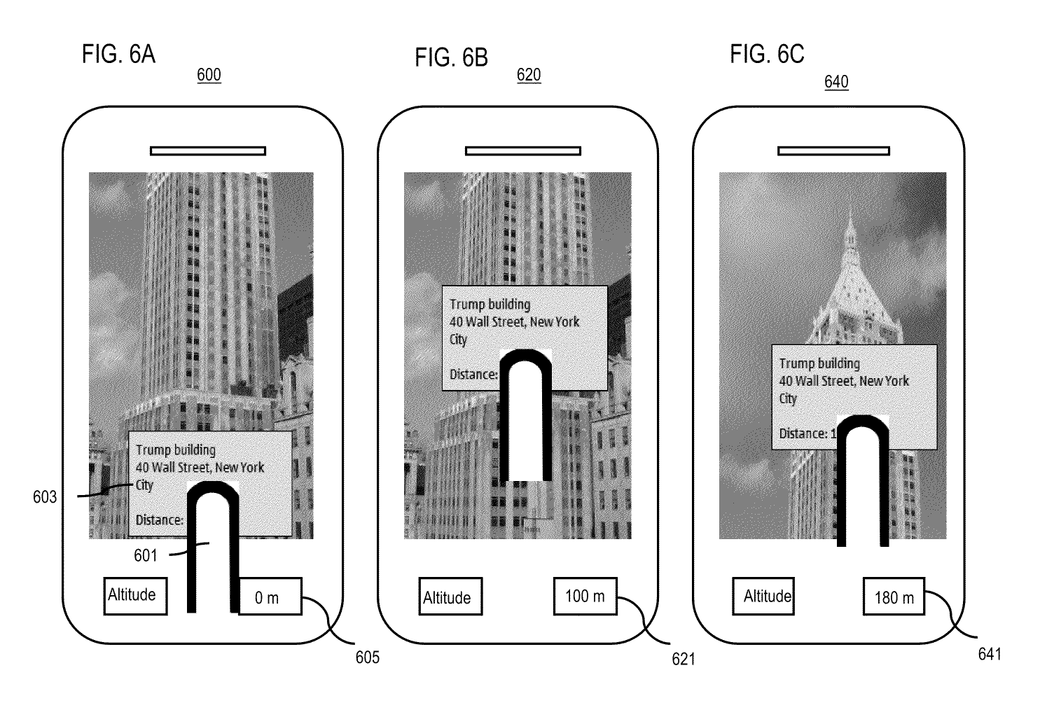

FIGS. 6A-6C are diagrams of user interfaces utilized in the process of FIG. 3, according to various embodiments. The user moves a finger 601 touching the screen of the UE 101 to drag a POI label 603 from an altitude 0 meter (605 in FIG. 6A) up to 100 meter (621 in FIG. 6B), and then up to 180 meter (641 in FIG. 6C) in altitude. As discussed, the application 107 converts the vertical drags (in pixels) into altitude readings in meters.

Similarly, when the user points the UE 101 at the nearby 5,989 feet (1825 m) long Brooklyn Bridge, the user can set a reference point as the foundation of the Bridge at one end (with a known address or GPS coordinates), and drag the POI label from the reference point vertically to the lower vehicle level or the upper bicycle/pedestrian level of the Bridge to set a first POI. The application 107 then calculates the heights of one of the levels using the above-discussed method, and calculates a vertical length there between to obtain the geographic coordinates of the first POI. When the user moves the POI label from the first POI along the upper level of the Bridge to an intermediate point on the bridge (i.e., a second POI), the application 107 calculates a distance there between with the above-discussed method to obtain the geographic coordinates of the second POI based on the coordinates of the first POI. The application 107 calculates the GPS coordinates of the POIs by using locally stored address or GPS data, without accessing any 2D or 3D digital maps or mapping models online. These 2D or 3D digital maps or mapping models are overloaded with data irrelevant to the POIs, and consume significant amount of time and rescores to download or access.

The user can further move the POI label to one of the bridge tower as a third POI to calculate the height of the bridge tower and to obtain the geographic coordinates of the third POI. With the coordinates of the third POI, the user can access data specifically directed to the bridge tower top without downloading or accessing a 3D mapping model of the Bridge. By way of example, the user can quickly access relevant information of the bridge tower top with the calculated coordinates, such as when the first time the tower top was completed, whether the bridge top is/was accessible for the public, any person jumped off the bridge tower top, etc.

The application 107 starts the calculation with the dimensions of the screen (the width, the vertical length, and the diagonal length). As more POIs are saved in the database 117, the application 107 can use recorded lengths to calculate non-horizontal, non-vertical, or non-diagonal lengths via geometry. To do so, the application 107 applies known algorithms to find the most relevant recorded length(s) for calculation. As results, the application of the above-described embodiments is not limited to structures. The above-described embodiments can be applied to any POI with an unknown address or GPS coordinates, as long as the POI is displayed in a live camera view together with a reference point with a known address or known geographic coordinates.

By way of example, when the user is walking in the Central Park in the New York City, the user uses the Zoo in the Park (with a known address) as a reference point to find out geographic coordinates of a carousel (i.e., POI) in the Park. The user points the UE 101 between the Zoo and the carousel to include both in a camera live view, and then drags a POI label from the Zoo to the carousel to set the carousel as the POI. The application 107 then calculates the geographic coordinates of the carousel based upon the address of the Zoo retrieved from the database 117. In this example, the application 107 does not need to access or display a 2D map or a 3D mapping model to find out the geographic coordinates of the carousel. The application 107 also retrieves for the user content relevant to the carousel, such as the history of the carousel, the hours and prices for riding the carousel, etc.

As another example, when the user is hiking and gets off a trail around the Yellowstone Lake in the Yellowstone National Park, the user uses a marina on the lakeshore (with known geographic coordinates) as a reference point to find out geographic coordinates of an anomalous location with a wonderful view (i.e., POI) on the lakeshore. The user points the UE 101 between the marina and the anomalous location, and drags the POI label form the marina to the view location to set the view location as the POI. The application 107 then calculates the distance between the view location and the marina based upon the geographic coordinates of the marina retrieved form the database 117.

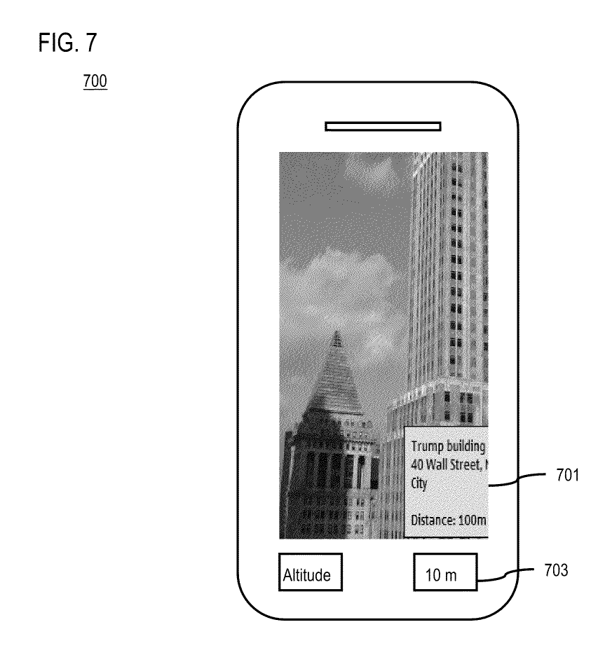

FIG. 7 is a diagram of a user interface utilized in the process of FIG. 3, according to one embodiment. As mentioned, the mapping and augmented reality application 107 causes, at least in part, augmenting and fixing a label at the POI in the live camera view on the screen, i.e., locking the viewpoint parameters (e.g., location, directional heading, and angle of elevation) of the UE 101 at a fixed viewpoint. Even if the UE 101 is moved or turned away, the content management module 215 renders the content from the locked viewpoint. The new altitude is now also reflected in the details dialog.

By way of example, after the POI label 701 is fixed to a POI, e.g., 10 meters (703 in FIG. 7) from the ground, if the user rotates the camera to the left, the Trump Building and the POI label 701 move to the right in the live camera view. Once a POI is set, the POI label shows content relevant to the POI, even if the POI label is no longer in the center of the screen when the user rotates the UE 101 away for the POI. When the user moves the live camera view totally away from the POI, the application 107 opens up a new window or a popup to display content relevant to the POI therein.

By way of example, as the user walks towards the Trump Building or walks into the Trump Building to catch up with the coming 1-hour sale, the UE 101 cannot continue display the 4^{th} and 5^{th} floors of the Trump Building in the camera live view. The application 107 starts a new window to show a 2D map with a route from the current location to the Trump Building as the user is walking towards the Building. As the user steps inside the Building, the application 107 starts another window to display the floor plan of the 4^{th} floor and a route to guide the user to the coming 1-hour sale on that floor as well as the products and pricing information. Therefore, the application 107 can quickly provide content closely relevant to the POI at the fixed GPS coordinates, using a locally stored 2D map, a downloaded floor plan and marketing data, without accessing any 2D or 3D digital maps or mapping models online.

The processes described herein for measuring geographic coordinates of a point of interest in a live camera view may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

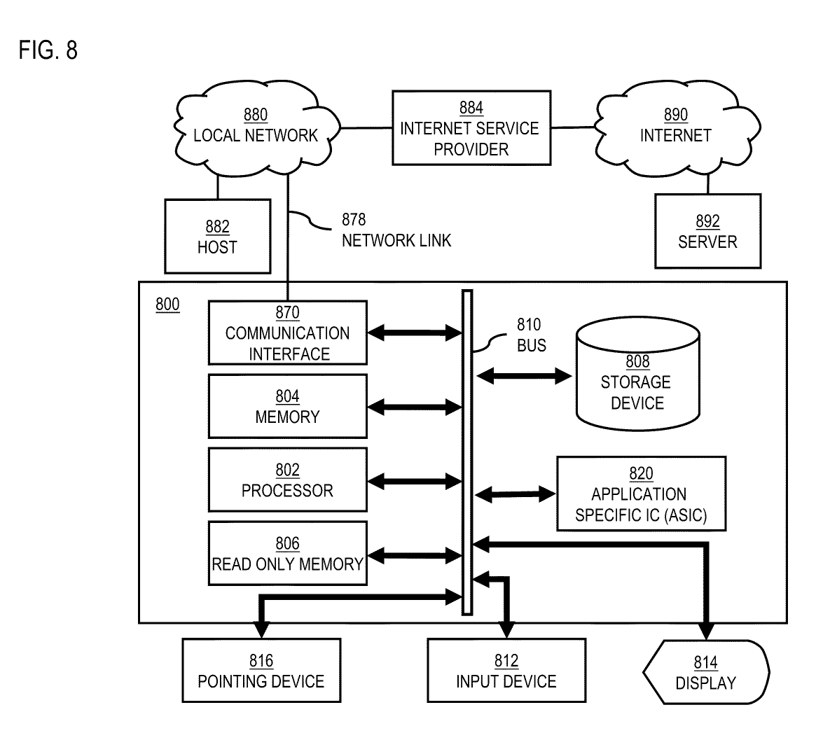

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to measure geographic coordinates of a point of interest in a live camera view as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of measuring geographic coordinates of a point of interest in a live camera view.

A bus 810 includes one or more parallel conductors of information so that information is transferred quickly among devices coupled to the bus 810. One or more processors 802 for processing information are coupled with the bus 810.

A processor 802 performs a set of operations on information as specified by computer program code related to measure geographic coordinates of a point of interest in a live camera view. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or other dynamic storage device, stores information including processor instructions for measuring geographic coordinates of a point of interest in a live camera view. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for measuring geographic coordinates of a point of interest in a live camera view, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT) or a liquid crystal display (LCD), or plasma screen or printer for presenting text or images, and a pointing device 816, such as a mouse or a trackball or cursor direction keys, or motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of application specific ICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection the UE 101 to the communication network 105 for measuring geographic coordinates of a point of interest in a live camera view.

The term “computer-readable medium” as used herein refers to any medium that participates in providing information to processor 802, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 808. Volatile media include, for example, dynamic memory 804. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

FIG. 9 illustrates a chip set 900 upon which an embodiment of the invention may be implemented. Chip set 900 is programmed to measure geographic coordinates of a point of interest in a live camera view as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 900, or a portion thereof, constitutes a means for performing one or more steps of measuring geographic coordinates of a point of interest in a live camera view.

In one embodiment, the chip set 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to measure geographic coordinates of a point of interest in a live camera view. The memory 905 also stores the data associated with or generated by the execution of the inventive steps.

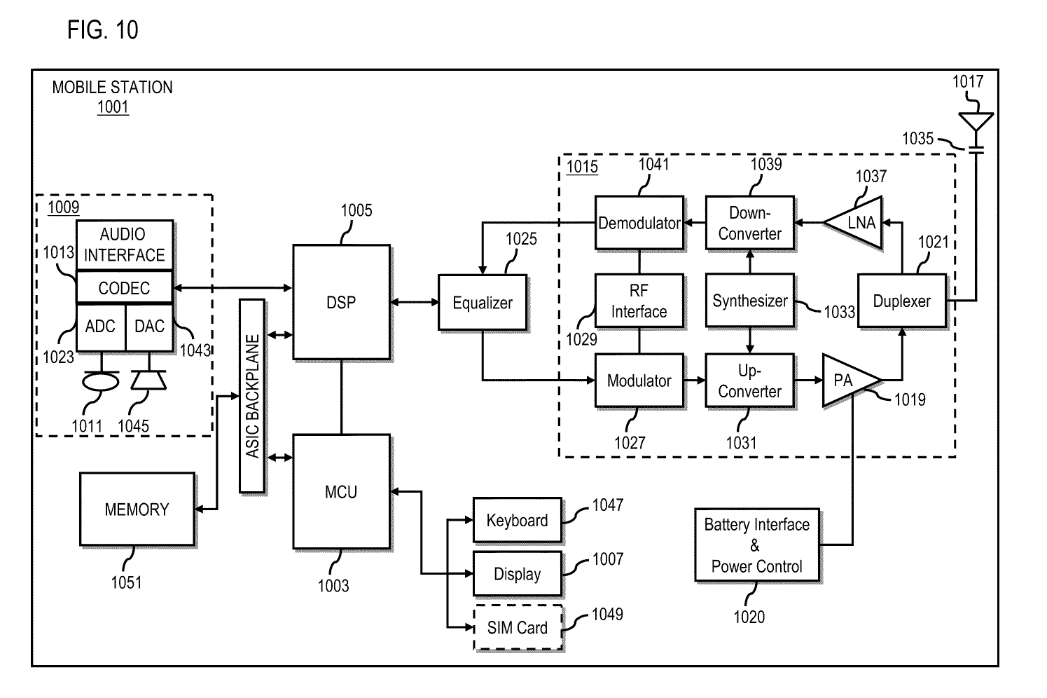

FIG. 10 is a diagram of exemplary components of a mobile terminal (e.g., handset) for communications, which is capable of operating in the system of FIG. 1, according to one embodiment. In some embodiments, mobile terminal 1000, or a portion thereof, constitutes a means for performing one or more steps of measuring geographic coordinates of a point of interest in a live camera view. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile terminal functions that perform or support the steps of measuring geographic coordinates of a point of interest in a live camera view. The display 10 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003—which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 to measure geographic coordinates of a point of interest in a live camera view. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The card 1049 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
causing, at least in part, presentation on a screen of an image including a point of interest and a reference point with a known address or known geographic coordinates, the image being associated with a location, a tilt angle, and a directional heading of a device used to capture the image;
causing, at least in part, detection on the screen of a length marked by a user from the reference point to the point of interest;
converting the length into a physical distance between the points; and
calculating geographic coordinates of the point of interest based upon the physical distance.

2. A method of claim 1, further comprising:
causing, at least in part, augmenting and fixing a label at the point of interest in the image on the screen.

3. A method of claim 1, further comprising:
retrieving data of a distance between the location of the device and a location of the reference point, a field of view of a camera incorporated in the device, and a dimension of the screen, thereby converting the length into the physical distance between the points.

4. A method of claim 3, further comprising:
determining at least one of the directional heading and the tilt angle of the device; and
modifying the physical distance between the points based upon the at least one of the directional heading and the tilt angle.

5. A method of claim 1, further comprising:
causing, at least in part, rendering of the screen to display at least one of the geographic coordinates of the point of interest, the physical distance between the points, and an altitude of the point of interest.

6. A method of claim 1, further comprising:
retrieving content directed to the point of interest based upon the geographic coordinates of the point of interest;
causing, at least in part, rendering of the screen to display the content.

7. A method of claim 6, further comprising:
causing, at least in part, reception of an input specifying a time period in the past, present, or future for rendering the content,
wherein the content is rendered with respect to the time period.

8. An apparatus comprising:
at least one processor; and
at least one memory including computer program code,
the at least one memory and the computer program code configured to, with the at least one processor, cause the apparatus to perform at least the following,
cause, at least in part, presentation on a screen of an image including a point of interest and a reference point with a known address or known geographic coordinates, the image being associated with a location, a tilt angle, and a directional heading of a device used to capture the image;
cause, at least in part, detection on the screen of a length marked by a user from the reference point to the point of interest;
convert the length into a physical distance between the points; and
calculate geographic coordinates of the point of interest based upon the physical distance.

9. An apparatus of claim 8, wherein the apparatus is further caused to:
cause, at least in part, augmenting and fixing a label at the point of interest in the image on the screen.

10. An apparatus of claim 8, wherein the apparatus is further caused to:
retrieve data of a distance between the location of the device and a location of the reference point, a field of view of a camera incorporated in the user device, and a dimension of the screen, thereby converting the length into the physical distance between the points.

11. An apparatus of claim 10, wherein the apparatus is further caused to:
determine at least one of the directional heading and the tilt angle of the device; and
modify the physical distance between the points based upon the at least one of the directional heading and the tilt angle.

12. An apparatus of claim 8, wherein the apparatus is further caused to:
cause, at least in part, rendering of the screen to display at least one of the geographic coordinates of the point of interest, the physical distance between the points, and an altitude of the point of interest.

13. An apparatus of claim 8, wherein the apparatus is further caused to:
retrieve content directed to the point of interest based upon the geographic coordinates of the point of interest;
cause, at least in part, rendering of the screen to display the content.

14. An apparatus of claim 13, wherein the apparatus is further caused to:
cause, at least in part, reception of an input specifying a time period in the past, present, or future for rendering the content,
wherein the content is rendered with respect to the time period.

15. A computer-readable storage medium carrying one or more sequences of one or more instructions which, when executed by one or more processors, cause an apparatus to at least perform the following steps:
causing, at least in part, presentation on a screen of an image including a point of interest and a reference point with a known address or known geographic coordinates, the image being associated with a location, a tilt angle, and a directional heading of a device used to capture the image;
causing, at least in part, detection on the screen of a length marked by a user from the reference point to the point of interest;
converting the length into a physical distance between the points; and
calculating geographic coordinates of the point of interest based upon the physical distance.

16. A computer-readable storage medium of claim 15, wherein the apparatus is caused to further perform:
causing, at least in part, augmenting and fixing a label at the point of interest in the image on the screen.

17. A computer-readable storage medium of claim 15, wherein the apparatus is caused to further perform:
retrieving data of a distance between the location of the device and a location of the reference point, a field of view of a camera incorporated in the device, and a dimension of the screen, thereby converting the length into the physical distance between the points.

18. A computer-readable storage medium of claim 17, wherein the apparatus is caused to further perform:
determining at least one of the directional heading and the tilt angle of the device; and
modifying the physical distance between the points based upon the at least one of the directional heading and the tilt angle.

19. A computer-readable storage medium of claim 15, wherein the apparatus is caused to further perform:
causing, at least in part, rendering of the screen to display at least one of the geographic coordinates of the point of interest, the physical distance between the points, and an altitude of the point of interest.

20. A computer-readable storage medium of claim 15, wherein the apparatus is caused to further perform:
retrieving content directed to the point of interest based upon the geographic coordinates of the point of interest;
causing, at least in part, rendering of the screen to display the content.
